(19) United States
(12) Patent Application Publication
(10) Pub. No.: US 2023/0029640 A1
(43) Pub. Date: Feb. 2, 2023

(54) REMOVAL OF WATER-IN-CRUDE OIL EMULSIONS USING HYDROPHOBIC AND HYDROPHILIC ACRYLIC MACROMOLECULES

(71) Applicant: INSTITUTO MEXICANO DEL PETRÓLEO, Mexico City (MX)

(72) Inventors: César Andrés Flores Sandoval, Mexico City (MX); Flavio Salvador Vázquez Moreno, Mexico City (MX); Gerardo Zavala Olivares, Mexico City (MX); Jessica Valeria Fuentes Santiago, Mexico City (MX); Edgar Benedicto Zamora Guerrero, Mexico City (MX); Enrique Cevada Maya, Mexico City (MX)

(21) Appl. No.: 17/679,004

(22) Filed: Feb. 23, 2022

(30) Foreign Application Priority Data
Jul. 21, 2021 (MX) MX/A/2021/008781

(51) Int. Cl. C10G 33/04; B01D 17/04; C08L 35/02

(52) U.S. Cl. CPC C10G 33/04; B01D 17/047; C08L 35/02; C10G 2300/202

(57) ABSTRACT

The present disclosure refers to the development of novel random bipolymers, which are comprised of alkyl acrylate and alkoxy alkyl acrylate monomers, as hydrophobic and hydrophilic components, respectively. These bipolymers are synthesized by means of semi-continuous emulsion polymerization, under strict conditions of monomer deficiency, to ensure the randomness and homogeneity of the chains. The application in dissolution of these random bipolymers has shown a dehydrating capacity superior to that of polyethers and phenolic resins, with the additional advantage of being soluble in crude oil. The random bipolymers show excellent performance as breakers of water-in-crude oil emulsions, coalescers of water droplets and clarifiers of the removed aqueous phase, and are chemically stable under acidic conditions.

### RELATED APPLICATIONS

This patent application claims priority under 35 U.S.C. § 119 based on Mexican Patent Application MX/a/2021/008781, filed on Jul. 21, 2021, the disclosure of which is incorporated herein by reference.

### FIELD OF THE DISCLOSURE

The present disclosure belongs to the field of chemical products for crude oil conditioning, particularly, to demulsifying chemical compounds. This disclosure is related to the application of macromolecules of controlled molecular mass —bipolymers— with a hydrophobic (alkyl acrylate) and hydrophilic (alkoxy alkyl acrylate) monomeric random distribution to destabilize and to break down water-in-crude oil (W/O) emulsions, in order to remove the emulsified water and, therefore, the salts dissolved in this last one, mainly, in triphasic separation units (inshore and offshore) for crude oils with gravity from 10 to 40° API.

### BACKGROUND OF THE DISCLOSURE

At present, most of the extracted crude oils is classified as heavy or extra-heavy, which have high content of water, salt dissolved in water and salts dispersed in crude oil. The water is found as water-in-crude oil (W/O) emulsion, whose stability is determined by the amount of natural surfactants in the crude oil. Regarding heavy or extra-heavy crude oils, the asphaltenes and resins, which are present in a large proportion in this type of crude oils, generate an interfacial barrier that hinders the coalescence of dispersed-water droplets in crude oil. The destabilization of emulsions is a complex process, since besides the presence of asphaltenes and resins, there are other factors that promote the emulsion stability Error! Reference source not found.-Error! Reference source not found.. The presence of water and salts in crude oil causes various problems, such as: corrosion and salt deposits in pipes and equipments, catalyst deactivation, presence of hot spots in refining processes, among others. Error! Reference source not found.,Error! Reference source not found.. For this reason, the dehydration process of crude oil must be carried out before the transportation to land or any unit operation for its processing. The chemical treatment, that is currently applied, takes place from the extraction platform, in this stage, formulations of triblock bipolymers based on polyethers, which display properties as demulsifying agent, are injected before the triphasic separator. However, these formulations exhibit several drawbacks: 1) the synthesis process of these compounds is complex, because it is carried out in two stages, both of them at high pressure and temperature; 2) in some countries there has been a reduction of raw material, mainly the ethylene oxide; 3) they undergo chemical degradation under conditions of acid stimulation of oil wells, which leads to a loss in the performance to remove the emulsified water in crude oil; and finally; 4) the formulation must be comprised by at least three different triblock bipolymers of different molecular mass in order to confer properties upon emulsion breaker, coalescer of water droplets and clarifier of the separated aqueous phase. Due to this last point, its cost is superior compared to any polymer that comprises all the three properties in a single molecule.

In order to avoid the chemical degradation of triblock bipolymers based on polyethers (PEO-PPO-PEO), the functionalization of the ending hydroxyl groups has been carried out employing secondary or tertiary amines, which confers to the triblock bipolymers, firstly, a higher chemical stability, avoiding the chemical degradation and, secondly, a better performance to remove the emulsified water in comparison with the non-functionalized triblock bipolymers. It is important to mention that a single basic of the triblock bipolymers functionalized with secondary or tertiary amines possesses the three required properties of a demulsifying agent; therefore, it is not necessary to make a formulation of several basics of functionalized triblock bipolymers. Nonetheless, the functionalization represents an additional synthesis step, which invariably impacts the final cost of the demulsifier agent but turning out to be more efficient than the non-functionalized triblock bipolymer based on polyethers, even, these are capable of integrating into a single molecule the three required demulsifying functions.

Based on the aforementioned products, different alternatives have been proposed by various research groups, in order to replace the use of non-functionalized triblock bipolymers. In this way, the US patent document No. 5,759,409 reports the separation of water from crude oil by means of a demulsifier that consists of a mixture of two compounds, the first one is a demulsifier based on polyethyleneimine alkoxylate, oligoamine alkoxylate, alkoxylated alkylphenol/formaldehyde resins, condensates of oligamine alkoxylates with di-carboxylic acids and alkylene oxide block copolymers or acrylic or methacrylic copolymers or terpolymers. The second compound could be any polyalkylene glycol ether, but without demulsifying activity. It should be pointed out that the mixture to synthesize theses demulsifying agents comprises a weight ratio of compound 1/compound 2 from 90/10 to 50/50 wt %. Finally, the dehydrating efficiency is reported based on 200 ppm of the formulation and depends strongly on the combination of the compounds that compose it.

On the other hand, the US document patent No. 8,722,593 describes the synthesis of alkoxylated thiacalixarenes and the use thereof as crude oil demulsifiers, which were assessed at 40 ppm in a German crude oil from Hebertshausen. However, the obtained removal efficiencies are scarcely between 75% and 94%.

The US document patent No. 7,981,979 reports the synthesis of cross-linked siloxanes, which contain alkoxy alkyl groups in its structure, as demulsifying agents of crude oil, dosed between 200 and 400 ppm, achieving water removal efficiencies between 30 and 46%, respectively.

The US document patent No. 9,981,207 describes compositions of polymers based on acrylamide in combination with acrylic and alkoxy alkyl acrylic monomers, which are useful as demulsifiers and clarifiers in oil-in-water emulsions (0/VV); where at least 40 mol % of the polymer should be polyacrylamide. However, the authors mention that, once the polymerization has been finished, the crosslinking process is carried out to make the demulsifying, and specifically, the clarification process more effective.

Zahran et al. described a novel series of nonionic surfactants functionalized with acrylic monomers to treat water-in-crude oil emulsions, which were assessed at 50, 100 and 200 ppm, showing a complete water removal in 30 min, employing the highest dosage. Nevertheless, the EMULDAC-AS-25-SC polymer is an ethoxylated block copolymer that is functionalized in four steps.

On the other hand, the synthesis of polymers based on acrylics, specifically alkyl acrylic and alkoxy alkyl acrylic, has been mentioned since the early of 70's decade. However, these were employed in industrial areas completely different from the petroleum field. For example, to produce (1) packaging, hoses or container seals, (2) acrylic elastomers with abrasion resistance for the cement industry, (3) films for food packaging or drugs and vapor-, gas- and air-impermeable coatings.

About the application of acrylic polymers in the petroleum industry, bipolymers and terpolymers based on alkyl acrylate have been reported as antifoaming agents for gasified crude oils], whereas random acrylic polymers as improving crude oil flow, different applications to the dehydration-desalting of crude oil.

The use of some acrylic polymers as demulsifying agents for crude oil has been reported, which is the case of the US patent document No. U.S. Pat. No. 10,793,783, that describes the use of bipolymers based on alkyl acrylic-carboxy acrylic with molecular masses between 900 and 472500 g mol⁻¹′. These bipolymers showed excellent performance as breakers, coalescers and clarifiers of the aqueous phase when were evaluated in crude oils with gravities from 5 to 40° API. In the same line of research, Fuentes et al. reported the performance of two series of bipolymers based on alkyl acrylic/carboxy alkyl acrylic and alkyl acrylic/acrylic acid as demulsifying agents of heavy crude oil, with dehydrating efficiencies that surpass two commercial formulations widely used in the petroleum industry. According to the obtained results by the research group, the selection of the monomer and the monomeric composition of the polymers significantly influences the demulsifying efficiency. Specifically, the 80/20 weight ratio of butyl acrylate /2-carboxyethyl acrylate allowed to reach the best demulsifying performance (100 vol %). Furthermore, it was established that characteristics and properties such as: the molecular mass of the bipolymer, the molecular volume, the polarizability, the refractivity and the affinity to crude oil and/or water are determining factors to consider in the design of new demulsifiers.

The bachelor thesis entitled “Novel demulsifying agents based on acrylics for the removal of water/crude oil emulsions”, Chavez, M., (2017), describes the synthesis, by means of emulsion polymerization, and the assessment of acrylic bipolymers in heavy crude oil, reporting water removal efficiencies higher to 50 vol %. However, the employed monomers are not mentioned, specifically during the synthesis and therefore, it is not possible to infer the structure of the employed compounds.

In a similar way, the bachelor thesis entitled “Theoretical-experimental study of the breakdown of water/petroleum emulsions by means of copolymers based on acrylics”, Garcia, R., (2016) describes the synthesis of bipolymers (copolymers) based on acrylics with different molecular masses, synthesized by semi-continuous emulsion polymerization. It is important to remark that the majority of polymers display demulsifying activity when are evaluated at dosages up to 100 ppm; nonetheless, the monomers or their structure are not mentioned; therefore, it is not possible to infer what combination of the acrylic monomers was employed in the research.

On the other hand, the US document patent No. 10,975,185 describes the outstanding performance of random bipolymers of controlled molecular mass as function of the composition, which are based on alkyl acrylic - amino acrylic. These bipolymers are synthesized by semi-continuous emulsion polymerization with the aim of controlling the number average molecular mass and the polydispersity index. The random bipolymers display resistance to the chemical degradation provoked by abrupt changes of pH and, furthermore, could be applied in heavy and light crude oils.

In the same line of research, Cevada et al., reports new demulsifying agents based on random bipolymers of different molecular mass, composed of butyl acrylate and 2-ethylhexyl acrylate monomers, which have an excellent demulsifying performance in heavy crude oils, specifically, when butyl acrylate is found at least in 70 wt % in the polymeric chain and the weight average molecular mass of the polymer is above 11000 g mol⁻¹. These bipolymers remove significant amounts of emulsified water when dosed at concentrations above of 1500 ppm.

On the other hand, the Mexican patent application No. MX/a/2020/011505 titled “Addition high random bipolymers to destabilize of complex emulsions in crude oil mixtures” reports bipolymers based on ethylene acrylic alkanoate capable of removing emulsified water in crude oil mixtures with gravities from 4 to 35° API; it is important to mention that the employed compounds have the potential to be scale-up at industrial level. These bipolymers can remove efficiently emulsified water at a dosage as low as 25 ppm.

Likewise, the international patent applications WO No. 2010/124773 and DE No. 10,2009,019,179 Al report the synthesis of biodegradable terpolymers based on acrylates and alkoxy alkyl methacrylates useful as emulsion breakers in W/O emulsions. These compounds have been dosed in amounts from 0.0001 to 5 wt % based on the oil content of the emulsion to be treated; whereas, the reported molecular mass of the copolymers is between 105 and 3103 g mol⁻¹. In addition, the authors affirm that these compounds exhibit better biodegradability in comparison with the commercially emulsion breaker known as “Dissolvan”. It should be noted that the described synthesis method consists of a batch polymerization, where the monomers are added at the beginning of the reaction and 1h later the initiator is added; subsequently, the mixture is kept under stirring for 5 h at a constant temperature. Finally, the solvent is removed under vacuum.

The foregoing background references are identified as follows:
[1] Schubert, H., Armbroster, H. (1992), Principles of Formation and Stability of Emulsions Intl. Chemical Engineering, 32(1), 14-28.
[2] Schramm, L. (1992), Emulsions: Fundamentals and Applications in the Petroleum Industry, Advanced Chemical Service Monograph Series, 231.
[3] Sjoblom, J. (2001), Encyclopedic Handbook of Emulsion Technology, Marcel Dekker.
[4] Gateau, P., Henaut, I., Barré, L., Argillier, J.F. (2004), Heavy Oil Dilution, Oil and Gas Science and Technology-Rev, IFP, 59(5), 503-509.
[5] Sanière, A., Henaut, I., Argillier, J.F. (2004), Pipeline Transportation of Heavy Oils, a Strategic, Economic and Technological Challenge, Oil and Gas Technology-Rev. IFP 59(5), 455-466.
[6] Fuentes, J.V., Zamora, E.B., Lopez, A., Alvarez, F., Zavala, G., Vázquez, F., Flores, C. (2019), Bipolimeros tribloques POE-POP-POE, con terminaciones anfotéricas, como agentes desemulsionantes de aceites crudos pesados, Mexican Patent Application MX/a/2019/005132.
[7] Fuentes, J.V., Zamora, E.B., Mariath, R., Li, Z., Xu, Z., Vazquez, F., Flores, C. (2020), Dehydrating Heavy Crude Oils with New Amphoteric Block Bipolymers, Energy Fuels 34,4307-4317.
[8] Wu, J., Xu, Y., Dabros, T., Hamza, H. (2005), Effect of EO and PO positions in nonionic surfactants on surfactant properties and demulsification performance, Colloids Surf. A: Physicochem. Eng. Aspect. 252,79-85.
[9] Flores, E., Flores, C., Reyes, R., Hernandez, J., Lopez, A., Castro, L., Alvarez, F., Estrada, A., Vazquez, F. (2017), Dehydrating and desalting compositions of crude oils, using triblock copolymers a,w-bifunctionalized with amines, U.S. Pat. No. 9,745,521.
[10] Cendejas, G., Arreguin, F., Castro, L., Flores, E., Vazquez, F. (2013), Demulsifying Super-Heavy Crude Oil with Bifunctionalized Block Copolymers, Fuel 103, 356-363.
[11] Zamora, E. B., Vazquez, F., Hernandez, E. I., Alvarez, F., Zavala, G., Lopez, A., Flores, C. A. (2018), Triblock copolymers functionalized with quaternary ammonium salts as dehydrating agents for heavy and extra-heavy crude oils, J. Disp. Sci. Technol. 39(10), 1502-1509.
[12] Knauf, W., Oppenlander, K., Slotman, W. (1998), Separation of water from crude oil and oil demulsifiers used for this purpose, U.S. Pat. No. 5,759,409.
[13] Dilsky, S. (2014), Alcoxylated thiacalixarenes and the use thereof as crude oil demulsifiers, U.S. Pat. No. 8,722,593.
[14] Flatt, A. (2011), Siloxane cross-linked demulsifiers, U.S. Pat. No. 7,981,979.
[15] Debord, J.D. (2018), Polymers useful as demulsifiers and clarifiers, U.S. Pat. No. 9,981,207.
[16] Zahran, M.A., Mohammady, M.M., Abd El-Raheem, H.M., Basuni, M.M. (2018), Facile development, characterization, and optimization of new nano-demulsifiers system for treating water-in-crude oil emulsions, Int. J. Thim. Fil. Sci. Tec. 3, 95-103.
[17] Jorgensen, A.H. (1970), Polymers of alkoxy alkyl acrylates, alkyl acrylates and vinyl or allyl chloroacetate, U.S. Pat. No. 3,488,331
[18] Emori, N., Ogawa, T., Arakawa, T., Kogure, T., Yokoyama, K., Kodaira, R. (2017),

Acrylic rubber, acrylic rubber composition, cross-linked acrylic rubber product, and seal member, U.S. Pat. No. 9,840,572.
[19] Starmer, P. (1972), Polymers of alkoxy alkyl acrylates, alkyl acrylates and substituted norbornene, U.S. Pat. No. 3,697,490.
[20] Atanasova, K., Hvilsted, S., Juel Fristrup, C. (2016), Polymer coating comprising 2-methoxyethyl acrylate units synthesized by surface-initiated atom transfer radical polymerization, U.S. Pat. No. 9,346,971.
[21] Seymour, D., Da Costa, N. (1973), Polymers of alkoxy and hydroxy alkyl acrylates or methacrylates, U.S. Pat. No. 3,780,003.
[22] Cevada, E., Castro, L., Hernandez, E., Flores, C., Lopez, A., Estrada, A., Alvarez, F., Estrada, A., Vázquez, F. (2017), Formulations of homopolymers based on alkyl acrylates used as antifoaming agents in heavy and super-heavy crude oils, U.S. Pat. No. 10,213,708.
[23] Hernandez, E., Cevada, E., Lopez, A., Flores, C., Alvarez, F., Estrada, A., Vazquez, F. (2019), Formulations of copolymers based on alkyl acrylates used as defoamers of heavy and super-heavy crude oils, U.S. Pat. No. 10,221,349.
[24] Hernandez, E., Lopez. A, Flores, C., Alvarez, F., Clavel, J., Vazquez, F., Cevada, E. (2017), Formulation of terpolymers based on alkyl acrylates employed as antifoaming of gasified heavy and super-heavy crude oils, U.S. Pat. No. 10,982,031.
[25] Lozada, M., Flores, E., Cendejas, G., Castro, L., Vázquez, F. (2016), Formulación de polimeros aleatorios para mejorar flujo de crudos del petróleo, Mexican Patent MX No. 338861.
[26] Castro, L.V., Flores, E. A., Cendejas, G., Lozada, M., Vazquez, F. (2018), Formulations of random polymers for improving crude petroleum flow, U.S. Pat. No. 9,932,430.
[27] Flores, C. A., Chavez, M. A., Zamora, E. B., Lopez, A., Zavala, G., Alvarez, F., Vázquez, F. (2020), Water/crude oil removers based on alkylacrylic-carboxyalkylacrylic random copolymers of controlled molecular mass, U.S. Pat. No. 10,793,783.
[28] Fuentes, J.V., Zamora, E.B., Li, Z., Xu, Z., Chakraborty, A., Zavala, G., Vazquez, F., Flores, C. (2021), Alkylacrylic-carboxyalkylacrylic random bipolymers as demulsifiers for heavy crude oils, Sep. Purif. Technol. 256, 117850.
[29] Chávez, M. (2017). Nuevos agentes desemulsionantes base acrilicos para la remoción de emulsiones agua/aceite crudo. Bachelor thesis. Escuela Superior de Ingenieria Quimica e Industrias Extractivas, Ciudad de Mexico, p.81, 86, 92-99.
[30] Garcia, R. (2016). Estudio teórico-experimental del rompimiento de emulsiones agua/petróleo mediante copolimeros base acrilicos. Bachelor thesis. Escuela Superior de Ingenieria Quimica e Industrias Extractivas, Ciudad de Mexico, p.111, 115-118, 121.
[31] Hernandez, E., Flores, C., Alvarez, F., Lopez, A., Garcia, R., Zavala, G., Clavel, J.,

Vazquez, F. (2018), Demulsifiers for crude oil based on acrylic-aminoacrylic random copolymers of controlled molecular mass, U.S. Pat. No. 10,975,185.
[32] Cevada, E., Palacios, N., Hernandez, E., Castro, L., Lopez, A., Flores, C., Vazquez, F.

(2019), Novel petroleum demulsifiers based on acrylic random copolymers, J. Disp. Sci. Technol., 40(4): 495-506.
[33] Gómez, E., Fuentes, J.V., Zamora, E.B., Vargas, C.J., Cevada, E., Zavala, G., Alvarez, F., Flores, C., Vázquez, F. (2020), Bipolímeros de adicion con alta aleatoriedad para desestabilización de emulsiones complejas en mezclas de aceites crudos, Mexican Patent Application No. MX/a/2020/011505.
[34] Gomez, E., Zamora, E. B., Vargas, C. J., Cevada, E., Vázquez, F., Zavala, G., Álvarez, F., Flores, C., Fuentes, J.V. (2020), Bipolmeros de adiciOn con alta aleatoridad para desestabilizaciOn de emulsiones complejas en rnezcias de aceites crudos, Mexican Patent Application MX/a/2020/011505.
[35] Schaefer, C., Cohrs, C., Dilsky, S. (2010), Use of biodegradable alkoxylated (meth)acrylate copolymers as crude oil demulsifiers, WO Patent Application No. 2010/124773.
[36] Cohrs, C., Dilsky, S., Schaefer, C. (2009), Alkoxylated (meth) acrylate polymers and their use as crude oil emulsion breakers, DE Patent Application No. 102,009,019,179.
[37] Schaefer, C., Cohrs, C., Dilsky, S. (2012), Alkoxylated (meth)acrylate polymers and the use thereof as crude oil demulsifiers, U.S. patent application Ser. No. 13/265,471.
[38] Bolto, B., Gregory, J. (2007), Organic polyelectrolytes in water treatment, Water research 41(11), 2301-2324.

### SUMMARY OF THE DISCLOSURE

Unlike the aforementioned documents, the present disclosure relates to new random bipolymers based on alkyl acrylate - alkoxy alkyl acrylate, process of obtaining and use, with properties as demulsifying agents of water in crude oil (W/O) emulsions. The synthesis of these bipolymers is carried out by means of a semi-continuous emulsion polymerization, under monomer starved-feed conditions, which ensures the random distribution of monomers. This synthesis process was developed at the Mexican Petroleum Institute and has been described in the Mexican patent No. MX 338861 B, besides in the US patent documents No. U.S. Pat. No. 10,213,708 and No. U.S. Pat. No. 9,932,430 B2. The synthesis process takes into account the use of chain transfer agents, which allows controlling the average molecular mass of the polymeric chains. This molecular parameter is of great importance, because the water removal efficiency of light or heavy crude oils depends strongly on it. The proportions of the alkyl acrylates and alkoxy alkyl acrylates monomers are adjusted; thus, the synthesized bipolymers are solely soluble in the organic phase, avoiding contamination of the separated aqueous phase, and therefore, a potential environmental problem [36]. It is worth mentioning that the bipolymers, object the present disclosure, are degraded to innocuous compounds once these reach the fractionating towers in subsequent refining stages.

The random bipolymers based on combinations of an alkyl acrylate and an alkoxy alkyl acrylate, object of the present disclosure, are methodically evaluated in crude oils with gravities from 10 to 40° API. The composition and average molecular mass of the novel random bipolymers based on alkyl acrylate and alkoxy alkyl acrylate can be tuned according to the characteristics of each crude oil, optimizing their performance as demulsifying agents in order to improve their efficiency/cost ratio compared to commercially available demulsifying agents for crude oil.

Therefore, the object of the present disclosure is to provide bipolymers based on alkyl acrylate and alkoxy alkyl acrylate capable of removing the emulsified water and the salts dissolved in this last one, in mixtures of crude oils with gravities from 10 to 40° API, being more efficient than conventional demulsifiers dose in triphasic separation units.

Another object of the present disclosure is to provide the use of bipolymers based on alkyl acrylates and alkoxy alkyl acrylates as dehydrating agents in crude oils, facilitating their transport, because of a decrease in their viscosity by the removal all the emulsified water in the crude oil and the salts dissolved on this.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Reference to the drawings below will be made with the aim of having a better understanding regarding the removal of water-in-oil emulsions using hydrophobic and hydrophilic acrylic macromolecules, object of the present disclosure:

FIG. 1 shows the performance of random bipolymers based on alkyl acrylate - alkoxy alkyl acrylate as demulsifying agents in the Xihil-1 light crude oil of 33.4° API, products of the present disclosure, which were synthesized with different monomeric composition, establishing the following nomenclature for them: KE-82, KE-73, KE-91 and KE-64, in order to be compared with the FD-1 commercial formulation —polyether formulation based on poly(ethylene oxide) /poly(propylene oxide) (PEO/PPO)— at a dosage of 1500 ppm.

FIG. 2 shows the images of the bottles and the micrographs of crude oil samples after the assessment of the KE-82 and KE-73 demulsifying agents —products of the present disclosure— and the FD-1 commercial formulation in the Xihil-1 light crude oil of 33.4° API, at a dosage of 1500 ppm. The crude oil samples treated with the aforementioned demulsifying agents are compared with the crude oil without demulsifier agent (labeled as blank). The micrographs show that the KE-82 and KE-73 random bipolymers are able to completely remove the emulsified water from crude oil, conversely, the micrograph of the crude oil treated with the FD-1 commercial formulation shows the presence of water droplets. Clarification of the removed water using the KE-82 and KE-73 random bipolymers is slightly higher than that observed with the FD-1 commercial formulation comprised of four PEO-PPO polyethers.

FIG. 3 shows the performance of random bipolymers based on alkyl acrylate -alkoxy alkyl acrylate, synthesized with different monomeric composition, as demulsifying agents in the Xihil-1 light crude oil of 33.4° API at a dosage of 1000 ppm and compared with the FD-1 commercial formulation.

FIG. 4 shows the images of the bottles and the micrographs of the crude oil samples after the evaluation with the KE-82 and KE-73 demulsifying agents —products of the present disclosure— and the FD-1 commercial formulation, in the Xihil-1 light crude oil of 33.4° API, at a dosage of 1000 ppm. The crude oil samples evaluated with the aforementioned demulsifying agents are compared with the crude oil sample without demulsifying agent (blank). The KE-82 and KE-73 random bipolymers are capable to remove 100 vol % of emulsified water, whereas the FD-1 commercial formulation scarcely removes 75 vol %. The clarification of the removed water using the KE-82 and KE-73 random bipolymers is higher than the obtained with the FD-lcom mercial formulation.

FIG. 5 shows the performance of random bipolymers based on alkyl acrylate -alkoxy alkyl acrylate, synthesized with different monomeric composition, as demulsifying agents in the Xihil-1 light crude oil of 33.4° API at a dosage of 500 ppm and compared with the FD-1 commercial formulation.

FIG. 6 shows the images of the bottles and the micrographs of the crude oil samples after the evaluation with the KE-82, KE-73, KE-91 and KE-64 demulsifying agents —products of the present disclosure— and the FD-1 commercial formulation, in the Xihil-1 light crude oil of 33.4° API, at a dosage of 500 ppm. The crude oil samples treated with the aforementioned demulsifying agents are compared with the crude oil samples without demulsifying agent (blank). The KE-82, KE-73, KE-91 and KE-64 random bipolymers were able to remove the 100 vol % of emulsified water, in contrast, the FD-1 formulation scarcely removed 63 vol %. The clarification of the removed water using the KE-82, KE-73 and KE-91 random bipolymers is higher than the observed with the FD-1 commercial formulation FD-1 and the KE-64 random bipolymer.

FIG. 7 shows the performance of random bipolymers based on alkyl acrylate -alkoxy alkyl acrylate, synthesized with different monomeric composition, as demulsifying agents in the Xihil-2 heavy crude oil of 20.2° API, at a dosage of 1500 ppm and compared with the FD-1 commercial formulation.

FIG. 8 shows the images of the bottles and the micrographs of the remaining emulsions in the crude oil samples after the evaluation with the KE-82 and FD-1 in the Xihil-2 heavy crude oil of 20.2° API, at a dosage of 1500 ppm. The crude oil sample evaluated with the aforementioned demulsifying agents are compared with the crude oil sample without demulsifying agent (blank). The KE-82 and FD-1 demulsifier agents were able to remove the 100 vol % of emulsified water. However, it should be noted that the clarification of the removed water employing the KE-82 random bipolymer is notably higher than the observed with the FD-1 commercial formulation.

FIG. 9 shows the performance of random bipolymers based on alkyl acrylate -alkoxy alkyl acrylate, synthesized with different monomeric composition, as demulsifying agents in the Xihil-2 heavy crude oil of 20.2° API, at a dosage of 1000 ppm and compared with the FD-1 commercial formulation.

FIG. 10 shows the images of the bottles and the micrographs of the crude oil samples after the evaluation with the KE-82 and FD-1 demulsifying agents in the Xihil-2 heavy crude oil of 20.2° API, ata dosage of 1000 ppm. The crude oil sample evaluated with the aforementioned demulsifying agents are compared with the crude oil sample without demulsifying agent (blank). The KE-82 random bipolymer was able to remove the 100 vol % of emulsified water, displaying a higher efficiency in comparison with the rest of random bipolymers. Furthermore, the removed water by the KE-82 bipolymer exhibits a better clarification in comparison to the obtained with the FD-1 commercial formulation, which removes 90 vol % of emulsified water.

FIG. 11 shows the performance of random bipolymers based on alkyl acrylate -alkoxy alkyl acrylate, synthesized with different monomeric composition, as demulsifying agents in the Xihil-2 heavy crude oil of 20.2° API, at a dosage of 500 ppm and compared with the FD-1 commercial formulation.

FIG. 12 shows the images of the bottles and the micrographs of the remaining emulsions in the crude oil after the evaluation of KE-82 and FD-1 demulsifying agents in Xihil-2 heavy crude oil of 20.2° API, at a dosage of 500 ppm. The samples of crude oil treated with the aforementioned demulsifier agents are compared with the crude oil without demulsifying agent (blank). KE-82 random bipolymer was able to remove the 100 vol % of emulsified water, on the contrary, the FD-1 commercial formulation barely removed 57 vol %. The clarification of the removed water using the KE-82 random bipolymer is superior to that observed with the FD-1 commercial formulation.

### DETAILED DESCRIPTION OF THE DISCLOSURE

The present disclosure is related to novel random bipolymers based on alkyl acrylate—alkoxy alkyl acrylate and their use as demulsifying agents of crude oil, specifically, to treat water/crude oil (W/O) emulsions, in order to remove the emulsified water and the salts dissolved in this last one, mainly, in the separation units set for crude oils (inshore and offshore) with gravities from 10 to 40° API.

The random bipolymers based on alkyl acrylate -alkoxy alkyl acrylate of the present disclosure are synthesized as latexes using semi-continuous emulsion polymerization as described in the Mexican patent No. MX 338861B [26]; the monomers should be added into the addition tank to form a pre-emulsion according to the following proportions: the alkyl acrylate monomer is set up on an interval between 55.0 and 99.0 wt % and the alkoxy alkyl acrylate monomer is set up on an interval between 1.0 and 45.0 wt %. Finally, the random bipolymer obtained as a latex is submitted to a distillation process at a temperature between 70 and 125° C. in order to obtain a viscous liquid. Afterwards, the random bipolymer —as a viscous liquid— is dissolved in an adequate organic solvent with boiling points between 30 and 250° C., such as: dichloromethane, methanol, ethanol, isopropanol, chloroform, acetone, dimethylsulfoxide, tetrahydrofuran, benzene and its derivatives, toluene, xylene, kerosene, jet fuel and naphtha; individually or as a mixture, for its final application as demulsifying agents of crude oils with gravities ranging from 10 to 40° API. The concentration of the random bipolymer in the solution is set up on an interval from 3.0 to 55.0 wt %; whereas the solution dosage in the crude oil can be set up on an interval of concentrations from 10 to 2000 ppm.

Formula (1) shows the structure of the random bipolymers based on alkyl acrylate—alkoxy alkyl acrylate of the present disclosure:

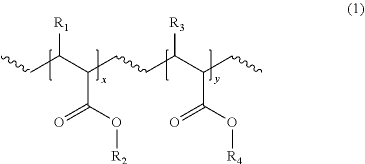

where: R₁, R₂, R₃ and R₄ are independent radicals represented by the groups that are hereby mentioned: R₁ and R₃=H (hydrogen) or CH₃ (methyl).

R₂=CH₃ (methyl), C₂H₅ (ethyl), C₄H₉ (n-butyl), C₄H₉ (iso-butyl), C₄H₉ (tent-butyl), C₅H₁₁ (pentyl), C₆H₁₃ (n-hexyl), C₆H₁₁ (di(ethylene glycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethylene glycol phenyl ether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₈H₃₇ (n-octadecyl), C₅H₉O (tetrahydrofurfuryl), C₅H₉O (2-tetrahydropyranyl), C₁₃H₂₇ (tridecyl) or C₂₂H₄₅ (behenyl). This aliphatic chain can contain heteroatoms of the ether group, as well as benzene type aromatic rings.

R₄=C₂H₅O (methoxymethyl), C₃H₇O (2-methoxyethyl), C₄H₉O (2-ethoxyethyl), C₄H₉O (3-methoxypropyl), C₅H₁₁O (3-ethoxypropyl), C₅H₁₁O₂ (2-(2-methoxyethoxy)ethyl) or C₈H₉O (2-phenoxyethyl). The alkoxy alkyl monomer can include phenyl groups or alkyl groups of cyclic or branched chains of C₁ to C₂₀.
where also:
x=is a number set up from 4 to 1000.
y=is a number set up from 4 to 1000.
“x” and “y′ can be present in random sequences.

The number average molecular masses (Mₐ) of the random bipolymers are set upon the interval ranging from 800 to 853000 g mol⁻¹.

The following alkyl acrylic monomers were selected to synthesize the random bipolymers object of the present disclosure, which does not represent any limitation: methyl acrylate, ethyl acrylate, butyl acrylate, pentyl acrylate, iso-butyl acrylate, tent-butyl acrylate, hexyl acrylate, 2-ethylhexyl acrylate, 3,5,5-trimethylhexyl acrylate, 4-tert-butylcyclohexyl acrylate, octyl acrylate, iso-decyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, iso-butyl methacrylate, tent-butyl methacrylate, hexyl methacrylate, 2-ethylhexyl methacrylate, 3,5,5-trimethylhexyl methacrylate, 4-tert-butylcyclohexyl methacrylate, octyl methacrylate, iso-decyl methacrylate, decyl methacrylate, lauryl methacrylate, tridecyl methacrylate, octadecyl methacrylate and behenyl methacrylate.

On the other hand, the alkoxy alkyl acrylic monomers in the present disclosure, which does not imply any limitation were selected from: 2-methoxyethyl acrylate, 2-phenoxyethyl acrylate, di(ethylene glycol)ethyl ether acrylate, 2-methoxyethyl methacrylate, 2-phenoxyethyl methacrylate, di(ethylene glycol)ethyl ether methacrylate, 2-ethoxyethyl acrylate, 2-ethoxyethyl methacrylate, 2-butoxyethyl acrylate, 2-butoxyethyl methacrylate, 2-ethoxymethyl acrylate, 2-ethoxymethyl methacrylate.

The random bipolymers of the present disclosure are dosed in effective quantities from 10 to 2000 ppm in crude oils with gravities from 10 to 40° API, in order to remove the emulsified water and the salts dissolved in the last one.

The present disclosure is described with reference to a specific number of examples, which are considered as illustrative and not as restrictive. Once the dried random bipolymer based on alkyl acrylate—alkoxy alkyl acrylate were obtained, these were characterized using the following instrumental methods:
1.-Size exclusion chromatography (SEC), employing an Agilent™model 1100 size exclusion chromatograph, with a PLgel column and using tetrahydrofuran (THF) as eluent, in order to obtain the number average molecular masses of bipolymers, as well as their polydispersity indexes (I).
2.-Fourier transform infrared spectroscopy (FTIR), using a Thermo Nicolet™ AVATAR 330 Fourier transform infrared spectrometer. The spectra were obtained using the film technique method, employing OMNIC™ 7.0 software for their processing.
3.-Nuclear magnetic resonance (NMR), the spectra were obtained in a Bruker Avance III HD spectrometer, the ¹H and ¹³C spectra were obtained at frequencies of 300 MHz and 75 MHz, respectively. Deuterated chloroform (CDCl₃) was used as solvent, while tetramethylsilane (TMS) was used as reference.

Table 1 reports the number average molecular mass and the polydispersity index obtained by SEC for the poly(alkyl acrylic—alkoxy alkyl acrylic), products of the present disclosure (R₁ and R₃=hydrogen, R₂=n-butyl, R₃=2-methoxyethyl), which does not imply any limitation.

### Examples

The following examples are shown to illustrate the spectroscopic characteristics of the random bipolymers based on alkyl acrylate—alkoxy alkyl acrylate employed as dehydrating agents in crude oils with gravities from 10 to 40° API. These examples must not be considered as limitation of what is claimed here.

TABLE 1
Number average molecular masses (M̅ₙ) and polydispersity indexes (l)
determined by SEC of the random bipolymers based on alkyl
acrylate—alkoxy alkyl acrylate of KE series with different
composition in wt % (products of the present disclosure).

| | Weight ratio | M̅ₙ | Polydispersity |
|---|---|---|---|
| Bipolymer | (wt %) | (g mol⁻¹) | index (l) |
| KE-91 | 90/10 | 17 080 | 1.98 |
| KE-82 | 80/20 | 18 061 | 1.67 |
| KE-73 | 70/30 | 18 215 | 1.40 |
| KE-64 | 60/40 | 18 950 | 1.35 |

KE series
Random bipolymers based on alkyl acrylate-alkoxy alkyl acrylate:
IR v cm⁻¹: 3 443, 2 958, 2 937, 2 878, 1 734, 1 456, 1 380, 1 246, 1 170, 1 066, 1 030.
¹H NMR δ (ppm): 4.20, 4.04, 3.55, 3.36, 2.30, 1.64, 1.60, 1.38, 0.94.
¹³C NMR δ (ppm): 174.64, 70.21, 64.55, 63.21, 58.76, 41.43, 35.34, 30.61, 19.10, 14.13, 13.75.

Evaluation of the random bipolymers based on alkyl acrylate—alkoxy alkyl acrylate as dehydrating agents for crude oils with gravities from 10 to 40° API.

Dissolutions of each one of the synthesized bipolymers were prepared, in a range of concentration from 3.0 to 55.0 wt %, using solvents with boiling points in the interval from 30 to 250° C., as dichloromethane, methanol, ethanol, isopropanol, chloroform, acetone, dimethylsulfoxide, tetrahydrofuran, benzene and its derivatives, toluene, xylene, kerosene, jet fuel and naphtha; individually or as a mixture. For its evaluation, an aliquot of the demulsifying agent was added at a specific concentration, in order to avoid any influence of the solvent on the destabilization of the emulsion and, consequently, affect the removal of water from the assessed crude oil. The random bipolymers based on alkyl acrylate—alkoxy alkyl acrylate were assessed at concentrations in the interval from 10 to 2000 ppm. The random bipolymers and the FD-1 commercial formulation were simultaneously assessed, being the last one widely employed in the petroleum industry. The FD-1 commercial formulation is comprised of four PEO-PPO-PEO triblock bipolymers of different number average molecular mass. Table 2 presents the PO/EO monomer ratio and the number average molecular mass of each triblock bipolymer that comprises the FD-1 commercial formulation.

TABLE 2
Key name, number average molecular mass (M̅ₙ), and
PPO/PEO ratio in wt % of the triblock bipolymers
comprise the FD-1 commercial formulation.
FD-1 formulation

| | M̅ₙ | PPO/PEO ratio |
|---|---|---|
| Key name | (g mol⁻¹) | (wt %) |
| TP 89 | 7 750 | 90/10 |
| TP 03 | 5 330 | 70/30 |
| TP 14 | 3 050 | 60/40 |
| TP 71 | 1 400 | 90/10 |

The performance of the bipolymers based on alkyl acrylates—alkoxy alkyl acrylates was assessed by means of dynamic bottle test; the procedure for the aforementioned assessment is described herein. The number of bottles was specified by the number of compounds to be assessed, besides of one additional bottle that corresponds to the crude oil without demulsifier —labeled as blank—. An aliquot of the dissolution of random bipolymers based on alkyl acrylate—alkoxy alkyl acrylate to be assessed and the commercial formulation FD-1 was added to each bottle, subsequently, the crude oil was poured into until the mark of 100 mL. The first reading of all bottles was taken at time cero, afterwards, the bottles were placed into a thermal controlled bath and immediately started the stirring of the laminar system at a speed of 60 cycles min⁻¹. The water-in-oil emulsion breakdown was measured periodically until the end of the assessment (5 h).

Table 3 displays the physicochemical characterization of the employed crude oils on the assessments of the random bipolymers based on alkyl acrylates—alkoxy alkyl acrylates as dehydrating agents.

TABLE 3
Physicochemical characterization of assessed crude oils to dehydration.

| Property | Xihil-1 | Xihil-2 |
|---|---|---|
| API gravity (°API) | 33.4 | 20.2 |
| Salt content (lb mbb⁻¹) | 1.34 | 151.00 ^{(a)} |
| Paraffins content (wt %) | 0.35 | 0.85 |
| Runoff temperature (° C.) | −39 | −18 |
| Water content by destination (vol %) | 8.0 | 21.0 |
| Water and sediments (vol %) | 8.2 | 21.1 |
| Kinematic viscosity (mm² s⁻¹) @ 25° C. | 9.1 | 764.6 |
| Number average molecular mass | 290 | 371 |
| by cryoscopy (g mob⁻¹) | | |
| Saturates (wt %) | 24.64 | 17.97 |
| Aromatics (wt %) | 31.65 | 17.12 |
| Resins (wt %) | 32.71 | 50.06 |
| Asphaltenes (wt %) | 11.26 | 14.71 |

^{(a)} The sample was diluted.

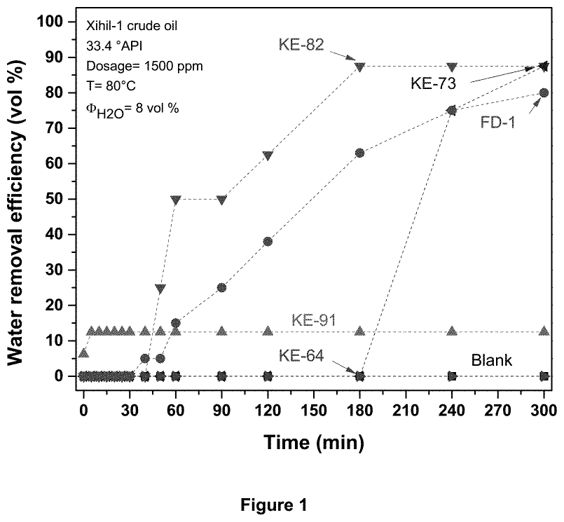

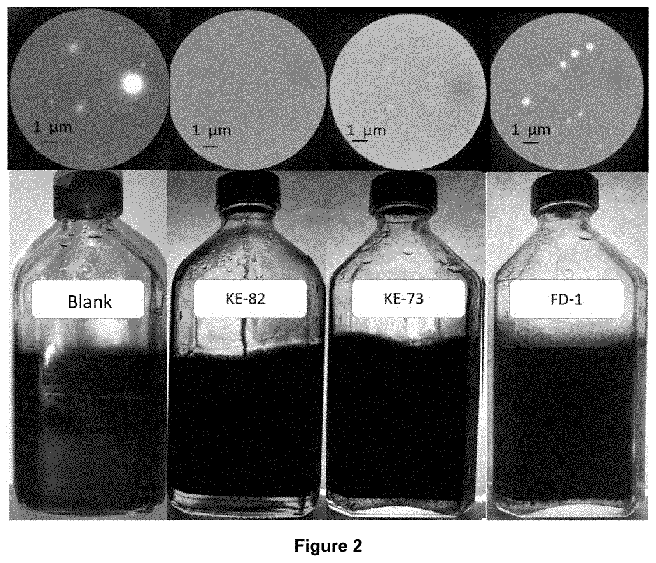

As demonstration, which does not imply any limitation, the results of the assessment of the water removal efficiency of the random bipolymers claimed in this disclosure as demulsifying agents are displayed in FIGS. 1, 3, 5, 7, 9 and 11; while FIGS. 2, 4, 6, 8, 10 and 12 show the images of the bottles and micrographs of the crude oils samples after the assessment with the demulsifying agents.

FIG. 1 displays the effect of the composition of the random bipolymers based on alkyl acrylate—alkoxy alkyl acrylate, at a dosage of 1500 ppm in the Xihil-1 crude oil with an API gravity of 33.4°. The KE-82 bipolymer was the first to achieve the destabilization of the water-in-oil emulsion at 40 min; however, at the end of the assessment, it removed the same amount of emulsified water than the KE-73 bipolymer, 88 vol %; which induced the emulsion destabilization until 240 min. The FD-1 commercial formulation prompted the emulsion breakdown at the same time that the KE-82 bipolymer; though, this showed a low coalescence rate, it reached a maximal water removal of 80 vol %. On the other hand, even though the KE-91 bipolymer exhibited the best performance as emulsion breaker, scarcely removed 13 vol % of emulsified water. Finally, the KE-64 bipolymer was not able to induce the emulsion breakdown.

FIG. 2 compares the bottle of the crude oil without demulsifier agent —blank— with the bottles of crude oil treated with the KE-82 and KE-731 random acrylic bipolymers, as well as the crude oil treated with the FD-1 commercial formulation. Firstly, it is observed the stability of the emulsion, because the blank sample does not display the presence of removed water. Secondly, a well-defined interface of removed water/crude oil can be distinguished in the KE-82 and KE-73 bipolymers, as well as for the FD-1 commercial formulation. Nonetheless, the aqueous phase clarification induced by the KE-82 bipolymer is slightly superior to the obtained with the KE-73 bipolymer and the FD-1 commercial formulation. On the other hand, the dehydrating efficiency of both random acrylic bipolymers is greater than that reached with the

FD-1 commercial formulation. This statement is confirmed with the micrographs of the crude oil after the treatment with the respective demulsifying agent, where it can be noticed in the micrographs of crude oil treated with the KE-82 and KE-73 random bipolymers, a low amount of emulsified water with water droplets size around 0.1 μm, whereas with the FD-1 commercial formulation, it is noticed a high amount of emulsified water with water droplets size of at least 5 times bigger than the aforementioned bipolymers.

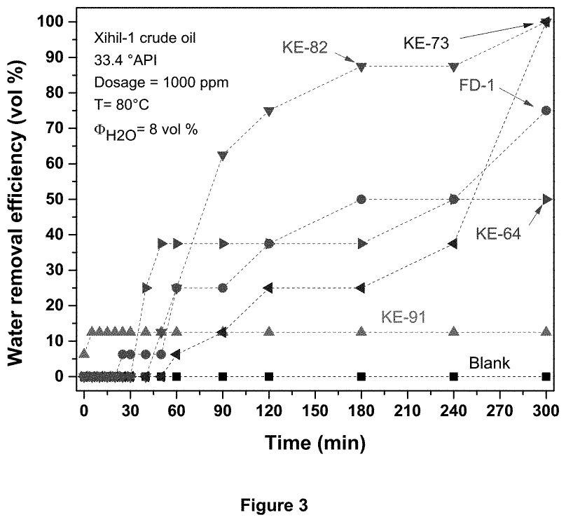

FIG. 3 shows the dehydrating performance of the random bipolymers of the KE series in the Xihil-1 crude oil (33.4° API), at a dosage of 1000 ppm. As can be observed, when the dosage is decreased the KE-82 and KE-73 bipolymers are able to utterly remove all the emulsified water at the end of evaluation. It is noteworthy to point out the high coalescence rate of the KE-82 random bipolymer during all the assessment in comparison with the KE-73 random bipolymer. Therefore, a high weight content of alkyl acrylate monomer prompts a higher diffusion through the natural surfactant barrier —asphaltenes and resines—, which is evidently reflected in a higher coalescence rate of the emulsified water droplets. On the other hand, the KE-64 random acrylic bipolymer displayed a low water removal performance, scarcely removing 50 vol %, being surpassed by the FD-1 commercial formulation, which was able to remove 75 vol %. Similar to the assessment with 1500 ppm, the KE-91 bipolymer exhibited the lowest water removal efficiency, barely removing 13 vol %.

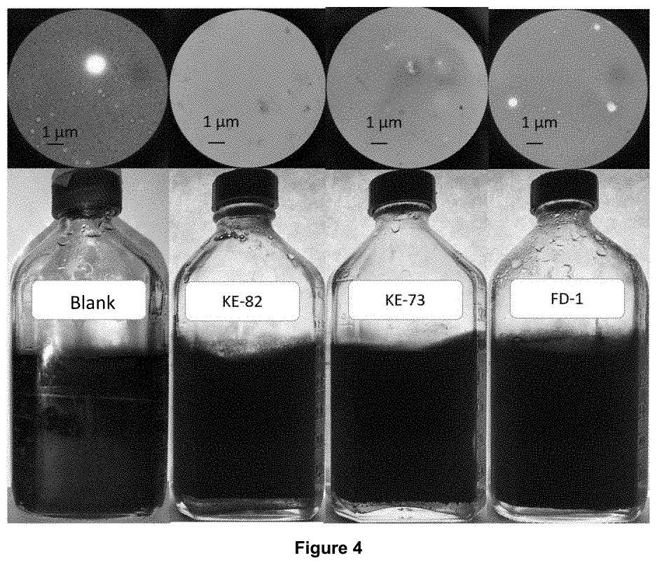

FIG. 4 compares the bottle of crude oil without demulsifier agent —blank— with the bottles of crude oil dosed with the KE-82 and KE-73 random acrylic bipolymers, furthermore, with the FD-1 commercial formulation. Firstly, the blank does not display the presence of removed water, which denotes the high stability of the water-in-crude oil emulsion. Moreover, it can be noted a homogeneous removed water/crude oil interface for the KE-82 and KE-73 random acrylic bipolymers, as well as for the FD-1 commercial formulation. It should be remarked that the clarification induced by the acrylic bipolymers and commercial formulation is excellent and comparable between them. However, the dehydrating efficiency of both bipolymers based on alkyl acrylate—alkoxy alkyl acrylate is superior to that of the FD-1 commercial formulation, which can be corroborated in the micrographs of the crude oil dosed with the KE-82 and KE-73 bipolymers, where are only observed conglomerates, possibly of paraffins or asphaltenes. In contrast, the micrograph of the crude oil treated with the FD-1 formulation displays remaining water/crude oil emulsion with a polydisperse droplet size between 0.1 and 0.6 μm.

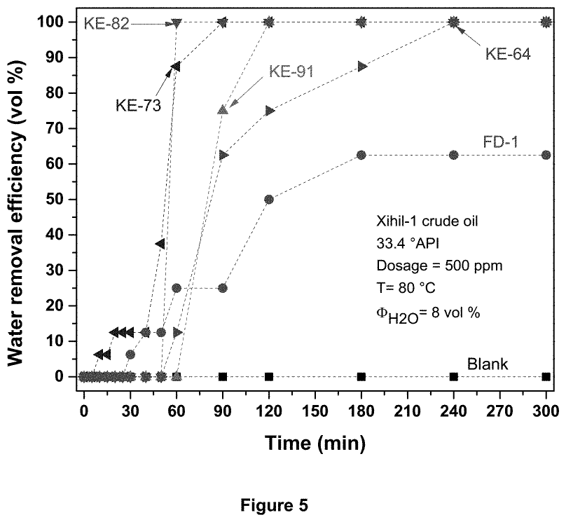

FIG. 5 reports the dehydrating performance of the random bipolymers of the KE series, assessed in the Xihil-1 crude oil (33.4° API), at a dosage of 500 ppm. It can be noted that, at this dosage, the KE-91, KE-82, KE-73 and KE-64 random acrylic bipolymers —based on alkyl acrylate—alkoxy alkyl acrylate— are able to withdraw all the emulsified water. The KE-73 random acrylic bipolymer displayed the best performance as emulsion breaker; nevertheless, about the coalescence performance, it was surpassed by the KE-82 random acrylic bipolymer, which achieved the total water removal at 60 min of the assessment, also displaying the highest coalescence rate. Conversely, even though the KE-91 bipolymer displayed the lowest emulsion breaking capacity, it displayed a better coalescence rate than the KE-64 random bipolymer and the FD-1 commercial formulation; being the last one, which showed the lowest coalescence rate, scarcely removed 60 vol %. In this sense, it is clear that, at a dosage of 1000 and 1500 ppm an overdose effect was observed, where, by one side, the KE-64 bipolymer displayed a diffusion hindrance through the crude oil and, while second side, although the KE-91 bipolymer was able to break the emulsion, the overdose of this bipolymer created a barrier around the water droplets that hindered the coalescence of water droplets. Therefore, at the lowest dosage, all random bipolymers displayed a better performance than the FD-1 commercial formulation.

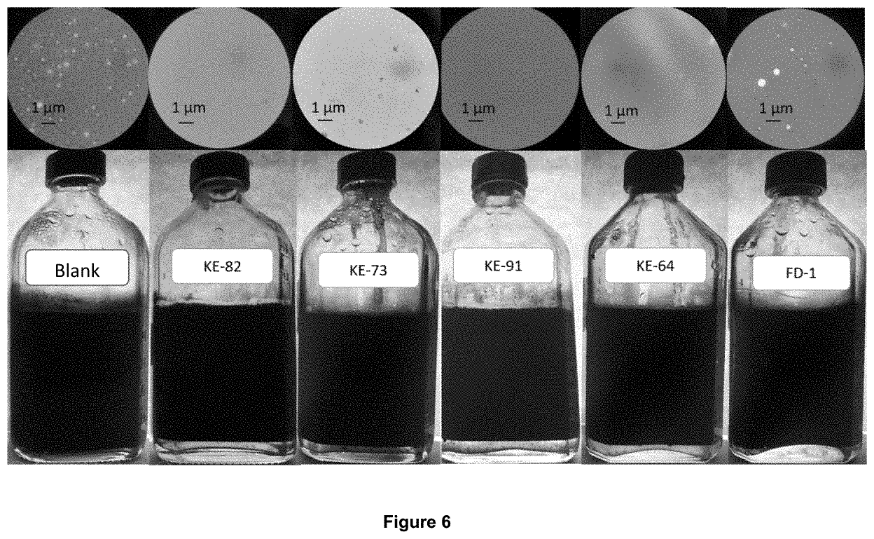

FIG. 6 compares the bottle of crude oil without demulsifier —blank— with the KE-91, KE-82, KE-73 and KE-64 random acrylic bipolymers, besides the FD-1 commercial formulation.

Firstly, there can be observed well-defined and homogeneous interfaces for the KE series and the FD-1 commercial formulation. Secondly, the KE-82 and KE-91 random bipolymers stand out for the excellent clarification of the removed water, while the KE-73 and KE-64 random bipolymers display a comparable clarification to that of the FD-1 commercial formulation. Regarding the water removal efficiency, the performance of the random acrylic bipolymers is highly superior compared with the commercial formulation. The aforementioned statement is evident on the micrographs of the crude oil dosed with the KE-82, KE-73, KE-91 and KE-64 bipolymers where there is no remaining emulsion, which confirms the total removal of emulsified water; on the other hand, the sample of crude treated with the FD-1 commercial formulation displays a remaining emulsion with water droplets size between 0.1 and 0.7 μm.

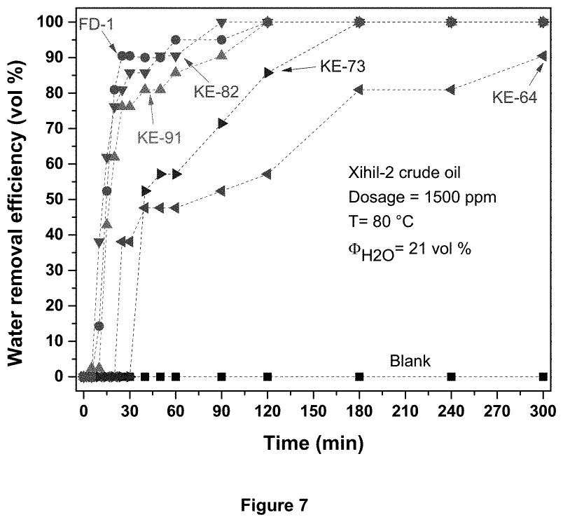

FIG. 7 depicts the performance of the random bipolymers based on alkyl acrylate -alkoxyalkyl acrylate assessed in the Xihil-2 heavy crude oil (20.2° API), at a dosage of 1500 ppm. As it can be observed, the KE-82 and KE-91 random acrylic bipolymers displayed a similar coalescence rate between them, though slightly underneath than that of the FD-1 commercial formulation. However, the KE-82 random acrylic bipolymer reached the total water removal 30 min before than the KE-91 random acrylic bipolymer and the FD-1 commercial formulation, both being able to withdraw the 100 vol % of emulsified water at 120 min. On the other hand, even though the KE-73 and KE-64 random acrylic bipolymers were the last to destabilize the emulsion, the KE-73 bipolymer reached the total water removal at 180 min; while the KE-64 bipolymer removed 90 vol %.

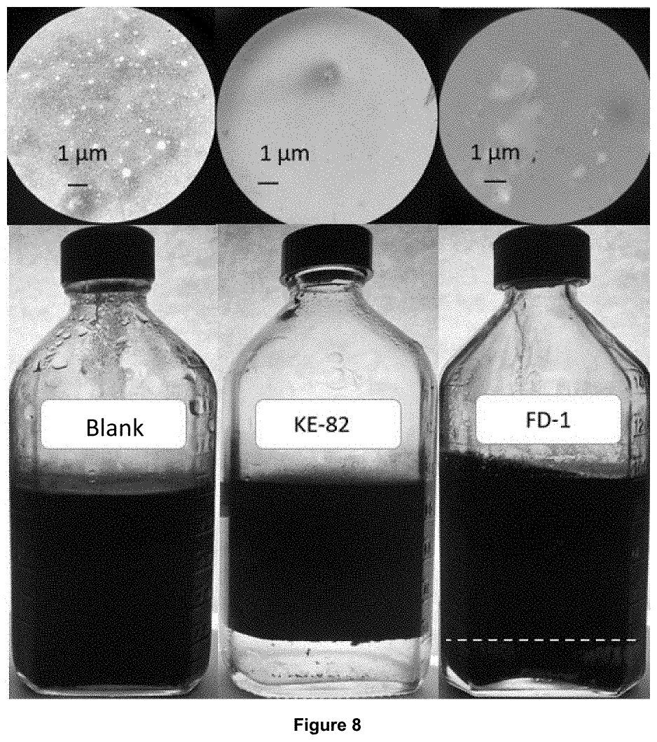

In FIG. 8 can be firstly observed that the emulsion was stable under the assessment conditions since the crude oil without demulsifier agent —blank— does not display the presence of removed water. On the other hand, a homogeneous interface can be distinguished for the KE-82 random acrylic bipolymer and the FD-1 commercial formulation. Nonetheless, the clarification induced by the KE-82 random acrylic bipolymer is remarkably better than that induced by the FD-1 commercial formulation, despite that both withdrew all the emulsified water. This last statement is confirmed by the micrographs of the crude oil dosed with each product, respectively.

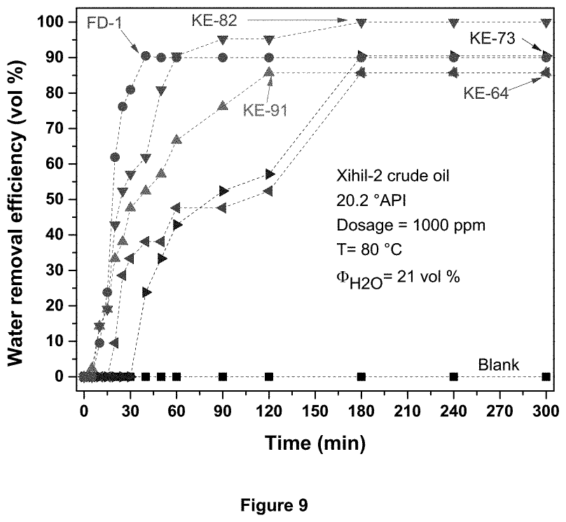

FIG. 9 shows the demulsifier performance of random bipolymers based on alkyl acrylate—alkoxy alkyl acrylate assessed in the Xihil-2 heavy crude oil (20.2° API), at a dosage of 1000 ppm. Overall, it could be observed that when the concentration of demulsifying agent is reduced, there is a dwindled in the water removal efficiency, with exception of the KE-82 random bipolymer, which achieved the complete removal of emulsified water at 180 min. On the other hand, even though the FD-1 commercial formulation showed the higher coalescence speed during the first 30 min of the evaluation, it only removed the 90 vol %. Even though the KE-73 bipolymer was the last one in destabilizing the emulsion, it reached the same water removal efficiency than the FD-1 formulation. Finally, the KE-91 random bipolymer induced the emulsion breakdown before than the KE-64 random bipolymer; yet, both reached a water removal of 86 vol %.

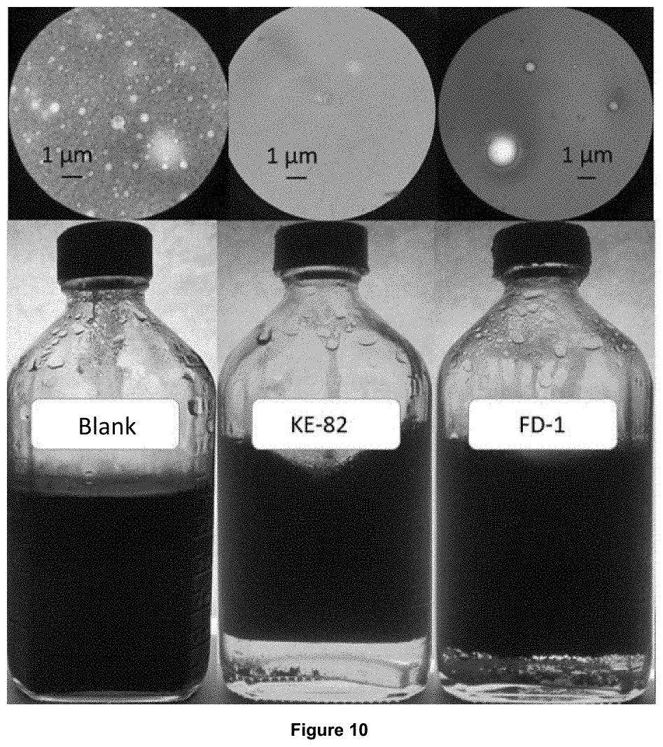

FIG. 10 displays, firstly, the high emulsion stability of the blank sample —without demulsifier agent—, where it is not observed the presence of removed water. Secondly, it is observed that the KE-82 random bipolymer and the FD-1 commercial formulation induce a homogenous and well-defined removed water/crude oil interface; furthermore, both displayed an excellent clarification of the removed water. On the other hand, about the micrograph of crude oil sample treated with the FD-1 commercial formulation, it is visible the presence of residual emulsion with water droplets size between 0.6 and 1.8 μm; whereas the micrograph of crude oil sample dosed with the KE-82 random acrylic bipolymer displays no remaining emulsion in the organic phase.

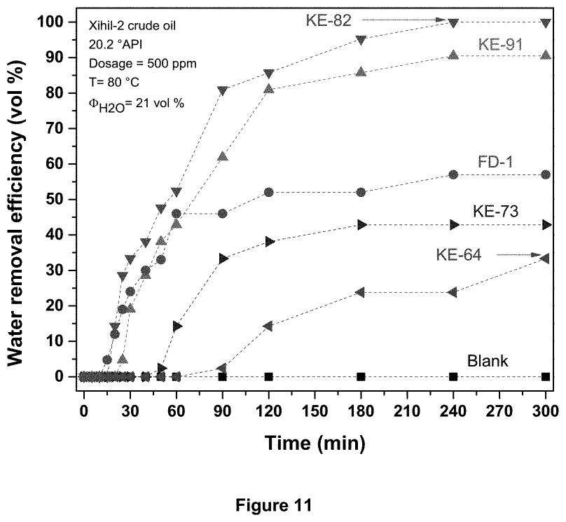

FIG. 11 displays the performance of random bipolymers based on alkyl acrylate—alkoxy alkyl acrylate assessed in the Xihil-2 heavy crude oil (20.2° API), at dosage of 500 ppm. As can be observed, all the demulsifying agents show a decrement in the coalescence rate.

However, the KE-82 bipolymer was the first one of all random acrylic bipolymers to destabilize the emulsion, exhibited the high coalescence rate and was able to remove all the emulsified water. Despite the fact that the KE-91 bipolymer showed a coalescence rate similar to that of the FD-1 commercial formulation during the first 60 min of testing, it achieved a notable higher water removal efficiency, 90 and 57 vol %, respectively. Finally, the KE-73 and KE-64 bipolymers showed a low demulsifying performance, barely removing 43 and 33 vol %, respectively.

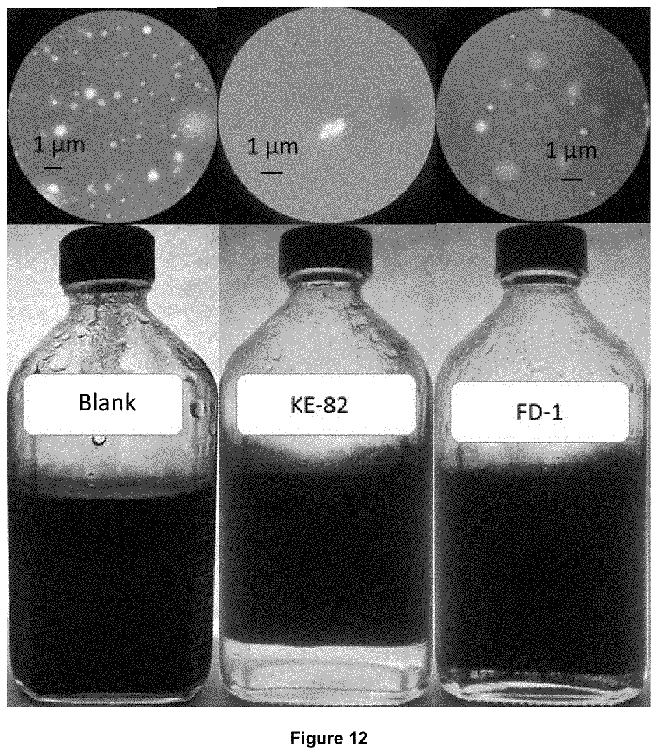

FIG. 12 compares the bottles of crude oil without demulsifier agent —labeled as blank—, with the bottles of crude oil treated with the KE-82 bipolymer and the FD-1 commercial formulation. It can be seen that both demulsifying agents induce a homogeneous removed water/crude oil interface. However, the KE-82 bipolymer stands out for having a significantly higher efficiency and clarification than the FD-1 commercial formulation. On the other hand, the micrograph of the crude oil treated with the KE-82 bipolymer shows no remaining emulsion in the organic phase; while the micrograph of the sample of crude oil dosed with the FD-1 commercial formulation, it is noticeable the presence of remaining emulsion with polydisperse water droplet sizes between 0.1 and 1.4 μm.

1. A demulsifier agent for removing emulsified water in crude oil, comprising a random bipolymer based on alkylacrylate—alkoxyalkylacrylate having the following structural formula (1) with molecular masses from 800 to 853 000 g mol⁻¹: 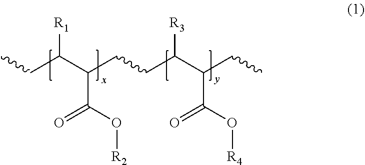
wherein:
R₁ and R₃=H (hydrogen) or CH₃ (methyl);
R₂=CH₃ (methyl), C₂H₅ (ethyl), C₄H₉ (n-butyl), C₄H₉ (iso-butyl), C₄H₉ (tent-butyl), C₅H₁₁ (pentyl), C₆H₁₃ (n-hexyl), C₆H₁₁ (di(ethylene glycol)ethylether), C₈H₁₇ (2-ethylhexyl), C₉H₁₉ (3,5,5-trimethylhexyl), C₈H₁₇ (n-octyl), C₈H₁₇ (iso-octyl), C₈H₉ (ethylene glycol phenyl ether), C₁₀H₂₁ (n-decyl), C₁₀H₂₁ (iso-decyl), C₁₀H₁₉ (10-undecenyl), C₁₀H₁₉ (tert-butylcyclohexyl), C₁₂H₂₅ (n-dodecyl), C₁₅H₃₇ (n-octadecyl), C₅H₉O (tetrahydrofurfuryl), C₅H₉ O(2-tetrahydropyranyl), C₁₃H₂₇ (tridecyl) or C₂₂H₄₅ (behenyl), and can optionally include heteroatoms of an ether group and/or benzene type aromatic rings;
R₄=C₂H₅O (methoxymethyl), C₃H₇O (2-methoxyethyl), C₄H₉O (2-ethoxyethyl), C₄H₉O(3-methoxypropyl), C₅H₁₁O(3-ethoxypropyl), C₅H₁₁O₂(2-(2-methoxyethoxy)ethyl) or C₈H₉O (2-phenoxyethyl), and can optionally include phenyl groups and/or alkyl groups of cyclic or branched chains of C₁ to C₂₀;
x=about 4 to about 1000;
y=about 4 to about 1000;
“x” and “y′ can be present in random sequences.

2. The demulsifier agent according to the claim 1, wherein the alkyl acrylate is selected from the group consisting of methyl acrylate, ethyl acrylate, butyl acrylate, pentyl acrylate, iso-butyl acrylate, tent-butyl acrylate, hexyl acrylate, 2-ethylhexyl acrylate, 3,5,5-trimethylhexyl acrylate, 4-tert-butylcyclohexyl acrylate, octyl acrylate, iso-decyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, iso-butyl methacrylate, tert-butyl methacrylate, hexyl methacrylate, 2-ethylhexyl methacrylate, 3,5,5-trimethylhexyl methacrylate, 4-tert-butylcyclohexyl methacrylate, octyl methacrylate, iso-decyl methacrylate, decyl methacrylate, lauryl methacrylate, tridecyl methacrylate, octadecyl methacrylate, behenyl methacrylate, and combinations thereof.

3. The demulsifier agent according to the claim 1, wherein the alkoxyalkyl acrylateis selected from the group consisting of 2-methoxyethyl acrylate, 2-phenoxyethyl acrylate, di(ethylene glycol)ethyl ether acrylate, 2-methoxyethyl methacrylate, 2-phenoxyethyl methacrylate, di(ethylene glycol)ethyl ether methacrylate, 2-ethoxyethyl acrylate, 2-ethoxyethyl methacrylate, 2-butoxyethyl acrylate, 2-butoxyethyl methacrylate, 2-ethoxymethyl acrylate, 2-ethoxymethyl methacrylate, and combinations thereof.

4. The demulsifier agent according to claim 1, comprising about 55 to about 99% by weight of the alkyl acrylate and about 1 to about 45% by weight of the alkoxy alkyl acrylate.

5. The demulsifier agent according to the claim 1, wherein the random bipolymer is formulated as a dissolution comprising organic solvent in an amount between abut 3 and about 60 wt %.

6. The demulsifier agent according to the claim 5, where the organic solvent has a boiling point from about 30 to about 250° C.

7. A method of using the demulsifier agent according to the claim 6, where the demulsifier agent is dosed at a concentration of about 10 to about 2000 ppm.
